(19) United States
(12) Patent Application Publication
(10) Pub. No.: US 2023/0268758 A1
(43) Pub. Date: Aug. 24, 2023

(54) RECHARGEABLE BATTERY DISCHARGE DEVICE FOR DISCHARGING RECHARGEABLE BATTERIES, AND METHOD FOR DISCHARGING A PLURALITY OF RECHARGEABLE BATTERIES

(71) Applicant: DUESENFELD GmbH, Wendeburg (DE)

(72) Inventor: Jonathan AHRENS, Braunschweig (DE)

(21) Appl. No.: 18/005,096

(22) PCT Filed: Jul. 12, 2021
(86) PCT No.: PCT/EP2021/069373

§ 371 Date: Jan. 11, 2023

(30) Foreign Application Priority Data
Jul. 13, 2020 (DE) 10 2020 118 418.2

(51) Int. Cl. H02J 7/00; H01M 10/44

(52) U.S. Cl. CPC H02J 7/007182; H02J 7/0034; H02J 7/0013; H02J 7/0047; H01M 10/441; H02J 2207/20

(57) ABSTRACT

The invention relates to a rechargeable battery discharge device (10) for discharging rechargeable batteries (20) with (a) a first rechargeable battery connection (12.1) for connecting a first rechargeable battery (20.1), (b) a second rechargeable battery connection (12.2) for connecting a second rechargeable battery (20.2), (c) at least a third rechargeable battery connection (12.3) for connecting a third rechargeable battery (20.3) and (d) a load connection (14) for a load (16) for dissipating an electric output during discharging of the rechargeable batteries (20). The invention provides for (e) a discharge circuit (18) comprising (i) a first short circuit switch (24.1), (ii) a first voltmeter (22.1) that is arranged to measure a first rechargeable battery voltage (U_{20.1}) dropped across the first rechargeable battery connection (12.1), (iii) a second short circuit switch (24.2), (iv) a second voltmeter (22.2) that is arranged to measure a second rechargeable battery voltage (U_{20.2}) dropped across the second rechargeable battery connection (12.2), (v) a third short circuit switch (24.3), (vi) a third voltmeter (22.3) that is arranged to measure a third rechargeable battery voltage (U_{20.3}) dropped across the third rechargeable battery connection (12.3), and (vii) a control unit (27), the control unit (27) being designed to automatically carry out a method comprising the steps: (i) for all voltmeters (22.i), detecting the respective rechargeable battery voltage (U_{20.i}), (ii) when the respective rechargeable battery voltage (U_{20.i}) exceeds a predetermined minimum voltage (Uₘᵢₙ), connecting the corresponding rechargeable battery (20.i) into a series circuit with at least one other rechargeable battery and (iii) when the respective rechargeable battery voltage (U_{20.i}) does not exceed a minimum voltage (Uₘᵢₙ), removing the corresponding rechargeable battery (20.i) from the series circuit by means of the corresponding short circuit switch.

The invention relates to a rechargeable battery discharge device for discharging rechargeable batteries with (a) a first rechargeable battery connection for connecting a first rechargeable battery, (b) a second rechargeable battery connection for connecting a second rechargeable battery, (c) at least a third rechargeable battery connection for connecting a third rechargeable battery and (d) a load connection for a load for dissipating an electric output during discharging of the rechargeable batteries.

Rechargeable batteries, which according to a preferred embodiment are lithium rechargeable batteries, are often discharged before recycling. The advantage of this is that chemical reactions are reduced or suppressed during recycling. When discharging, it should be ensured that this does not cause the destruction of the rechargeable battery.

Rechargeable batteries are usually installed in battery modules. Such a battery module usually comprises a large number of galvanic cells, which can be grouped together to form sub-units. A battery module, for example for an electric vehicle, usually comprises a large number of galvanic cells. They may have different charging levels and different states of wear. To prevent a catastrophic failure of one or multiple galvanic cells of the rechargeable battery, it is extremely advantageous to avoid a deep discharging of the rechargeable battery.

During operation of a battery module, they are usually charged and discharged by a so-called battery management system in such a way that deep discharging cannot occur. However, if a battery module is defective, the battery management system can generally no longer be accessed. In addition, the charge level of the individual rechargeable batteries is largely unclear. To be able to recycle them, the rechargeable batteries are therefore discharged individually.

For this purpose, it is common to individually connect the rechargeable batteries to a load, so that the energy content still contained in the rechargeable battery is dissipated via the load. This has the disadvantage that a large number of loads, which may be ohmic resistances for example, have to kept on stand-by.

To avoid this, multiple rechargeable batteries can be connected in parallel. This leads to high electric currents to ensure that the time required for discharging is not too long. The requirement for such a method is that the charge levels do not differ too starkly from one another: for example, the charge levels can differ from one another by a maximum of 10%.

It is also known to connect the rechargeable batteries in series and discharge them together. However, this is only possible when the charge levels of the individual rechargeable batteries barely differ from each other, in particular by less than 1%. In practice, however, this can only be ensured with considerable effort, as the charge levels must be determined.

In addition, to circumvent these aforementioned problems, it has been suggested that the electrolyte be removed before further recycling to prevent runaway.

It is also known to freeze the rechargeable batteries with liquid nitrogen and to comminute them in this state, as no chemical reaction is possible in the frozen state. These methods are relatively energy-intensive.

JP 2019-071701 A discloses a discharge treatment method of waste batteries that performs a discharge treatment of a plurality of waste unit cells. Here, a main circuit resistor is connected between an anode of one end and a cathode of the other end of the plurality of waste unit cells connected in series, and auxiliary circuit resistors and auxiliary switches are respectively connected in series between the anode and the cathode of each of the plurality of waste unit cells. The method includes a standard time discharge step and a discharge step during a polarity reversal of rechargeable batteries in which cells that are not in a polarity reversal state are continually discharged. To this end, auxiliary switches that are connected with the waste unit cells in the polarity reversal state are closed. This prevents a runaway of the cells, as they do not enter the polarity reversal state.

DE 10 2014 207 239 A1 describes a method for disposing of an energy storage system with multiple electrochemical cells, said system using a balancing control device of the energy storage system for targeted deep discharging of the energy storage system. The deep discharging process is initiated externally. The energy stored in the galvanic cells is converted into heat via the internal resistance of the cells.

DE 10 2013108 023 A1 concerns a system for increasing the safety of rechargeable batteries that are installed in electric cars. In the event of an accident, a targeted discharging of the battery cells occurs using a cell balancing circuit. In the process, the energy content of the batteries is converted into heat.

DE 10 2016 206 919 A1 details the balancing of cell charge levels. To this end, cell pairs are connected to each other via an external balancing circuit for generating an external balancing current between the cell pairs.

DE 10 2016 224 002 A1 details the discharging of a battery module by selectively electrically coupling battery cells of the battery module to be discharged one after the other to a discharging device by means of a cell switching unit, starting from a predetermined battery cell, in order to electrically discharge the battery cells one after the other individually in order to discharge the battery module.

The invention is based on the task of improving the discharging of rechargeable batteries, in particular within the context of a disposal method.

The invention solves the problem by way of a rechargeable battery discharge device according to the preamble that comprises (e) a discharge circuit, (i) a first short circuit switch, (ii) a first voltmeter that is arranged to measure a first rechargeable battery voltage dropped across the first rechargeable battery connection, (iii) a second short circuit switch, (iv) a second voltmeter that is arranged to measure a second rechargeable battery voltage dropped across the second rechargeable battery connection, (v) a third short circuit switch, (vi) a third voltmeter that is arranged to measure a third rechargeable battery voltage dropped across the third rechargeable battery connection, and (ii) a control unit, (f) the control unit being designed to automatically carry out a method comprising the steps (i) for all voltmeters, detecting the respective rechargeable battery voltage, (ii) if the respective rechargeable battery voltages exceed a predetermined minimum voltage, connecting (and/or keeping connected) the corresponding rechargeable battery into a series circuit with at least one other rechargeable battery, particularly by means of the corresponding short circuit switch, and (iii) if the respective rechargeable battery voltages do not exceed the minimum voltage, removing the corresponding rechargeable battery from the series circuit, particularly by means of the corresponding short circuit switch.

According to a second aspect, the invention solves the problem by way of a method for discharging a plurality of rechargeable batteries with the automatically conducted steps: (a) continually measuring one rechargeable battery voltage of a plurality of rechargeable batteries, (b) connecting the rechargeable batteries whose rechargeable battery voltages do not fall below a predetermined minimum voltage into a series circuit, so that the rechargeable batteries are discharged, and (c) decontacting a rechargeable battery whose rechargeable battery voltage falls below the predetermined minimum voltage, so that it is not longer connected in series.

The advantage of the invention is that the rechargeable batteries can be automatically discharged. It may only be necessary to manually connect the rechargeable batteries to one rechargeable battery at a time.

It is also advantageous that only a small number of loads have to be supplied. It is possible to use multiple loads, but it is not necessary. In particular, it is possible to reuse the energy still stored in the rechargeable batteries as useful energy. In other words, it is possible, but not necessary, for the electrical energy stored as heat in the rechargeable batteries to be dissipated. In particular, it can be supplied to a consumer as electrical energy.

It is beneficial that discharging the rechargeable batteries can usually be performed very safely, as it is ensured that the voltage does not fall below the predetermined minimum voltage. The minimum voltage is preferably selected in such a way that a runaway of the rechargeable battery is avoided. For example, the minimum voltage is zero Volt.

It is also beneficial that the rechargeable battery discharge device can be used to discharge rechargeable batteries with any charge level and/or residual voltage. Therefore, the operator of the rechargeable battery discharge device does not usually require any knowledge of the rechargeable battery to be discharged. In addition, the likelihood of improper operation is usually low.

Within the scope of the present description, a rechargeable battery is understood to be a component that electrochemically stores electrical energy. A rechargeable battery comprises at least one galvanic element, preferably a large number of galvanic elements. In other words, the rechargeable battery may be a battery, i.e. a combination, especially a series circuit, of multiple galvanic cells. In addition, it is possible that the rechargeable battery comprises two or more independent batteries.

The rechargeable batteries are preferably at least largely, in particular exclusively, lithium rechargeable batteries. A lithium rechargeable battery is understood particularly to be a rechargeable battery in which the electrochemical reaction is based on lithium. The lithium rechargeable battery is preferably a lithium-ion rechargeable battery. However, it does not necessarily have to be a lithium rechargeable battery: the invention can also be used for other types of rechargeable battery. In addition, it is possible, but not necessary, for all rechargeable batteries to have the same design. Specifically, it is also possible to connect rechargeable batteries of different designs.

A short circuit switch is understood particularly to be a device by means of which a current can be suppressed by the corresponding rechargeable battery. Specifically, the short circuit switch is designed to bridge the respective rechargeable battery connection. The first short circuit switch can therefore be used to short the poles of the first rechargeable battery connection together when the minimum voltage is zero Volt. Each rechargeable battery connection has at least two poles, which can also be referred to connection contacts.

For example, the short circuit switches are relays. However, all other potential-free switching switches or potential-switching switches, in particular semi-conductor switches, can also be used as short circuit switches.

In particular, the series circuit is understood to be a circuit in which the voltages of at least two rechargeable batteries, in particular a plurality of rechargeable batteries, connected electrically to one another in a circuit, are added together. It is possible, but not necessary and usually not practical, for two or more rechargeable batteries to be connected in parallel.

According to a preferred embodiment, the rechargeable battery discharge device has a display for displaying the rechargeable batteries whose respective rechargeable battery voltages do not exceed the minimum voltage and/or the rechargeable battery connections whose connection contacts are bridged. This has the advantage that an operator of the rechargeable battery discharge device can determine which rechargeable batteries can be removed. It is to be noted that a display that shows the rechargeable batteries whose respective rechargeable battery voltage does not exceed the minimum voltage can also be realised by showing the rechargeable batteries whose respective rechargeable battery voltage falls below the minimum voltage and/or showing the rechargeable battery connections whose connection contacts are not bridged. From the lack of such a signal, it can be deduced that, for the corresponding rechargeable battery, the rechargeable battery voltage does not exceed the minimum voltage and/or that the corresponding connection contacts are bridged.

A display is understood particularly to mean a device by means of which an operator can obtain information as to which rechargeable battery connections have fallen below the minimum voltage or the connections contacts whose rechargeable battery connections are short-circuited. It is possible that this display is an optical display that emits an optical signal. However, it is possible that the display is an electric, haptic display or another display. In particular, it is also possible that the display only emits an electrical signal, so that, for example, a robot that forms part of the rechargeable battery discharge device according to a preferred embodiment automatically separates the corresponding rechargeable battery whose minimum voltage is not reached from its rechargeable battery connection. Specifically, the robot can also be designed to automatically place discharged rechargeable batteries at a predetermined location. This location may be a different container or a conveyor, for example, which transports the discharged rechargeable batteries for further processing.

It is advantageous if the rechargeable battery discharge device comprises a polarity reversal protection circuit. In particular, this polarity reversal protection circuit is designed to automatically detect a rechargeable battery whose poles are incorrectly connected. It is beneficial if the polarity reversal protection circuit is designed to emit a polarity reversal warning and/or to connect the incorrectly connected rechargeable battery with the correct polarity.

For example, the polarity reversal protection circuit may comprise a polarity reversal circuit. The polarity reversal circuit is designed to automatically reverse the polarity of the voltage acting on the connection contacts of the respective rechargeable battery connection. As a result, the rechargeable battery that was initially incorrectly connected is now connected with the correct polarity. In this case, it is irrelevant if the rechargeable battery is connected to the connection contact of the respective rechargeable battery connection with the incorrect polarity, as the polarity reversal circuit ensures that the rechargeable battery is switched into the series circuit with the correct polarity.

A polarity reversal warning is understood especially to be a notification that encodes the rechargeable battery connection to which a rechargeable battery is connected with the incorrect polarity. The polarity reversal warning may be detectable or non-detectable to humans. In particular, it can be an optical, acoustic or electrical polarity reversal warning.

Alternatively or additionally, the polarity reversal protection circuit is designed in such a way that it does not switch a rechargeable battery connected with the incorrect polarity into the series circuit.

According to a preferred embodiment, the control unit is designed to automatically carry out a method comprising the steps (i) determining rechargeable battery voltage changes of rechargeable battery voltages over time and (ii) disconnecting the corresponding rechargeable battery from the series circuit by means of the corresponding short circuit switch and/or emitting a voltage disconnection warning when the rechargeable battery voltage change over time falls outside of a predetermined tolerance interval. Too stark a change in rechargeable battery voltage over time indicates that the corresponding rechargeable battery has a malfunction. To prevent an electric current through the rechargeable battery leading to damage to the rechargeable battery or exacerbating existing damage, the corresponding rechargeable battery is preferably bridged, meaning that a current no longer flows through the rechargeable battery connection into the rechargeable battery.

It is advantageous if the control unit is designed to re-contact this rechargeable battery, i.e. switching the rechargeable battery into the series circuit. If the voltage of the rechargeable battery once again changes over time such that it lies outside of the predetermined tolerance interval, the corresponding rechargeable battery can be rebridged and/or a voltage disconnection warning issued. Re-contacting is understood particularly to mean that the corresponding rechargeable battery is switched back into a series circuit with at least one other rechargeable battery. This is achieved by means of the corresponding short circuit switch. Decontacting is understood particularly to mean a removal from the series circuit.

The control unit is preferably designed to automatically carry out a method comprising the step of switching some of the rechargeable batteries into the series circuit, so that a sum of the rechargeable battery voltage lies within a predetermined target voltage interval. If two or more combinations of rechargeable battery voltages lie within the target voltage interval, the combination with the larger number of rechargeable battery voltages is preferably selected. Preferably, all rechargeable batteries whose rechargeable battery voltages are above the minimum voltage are connected in series when the sum of all rechargeable battery voltages is smaller than a lower interval boundary of the target voltage interval. In this way, a voltage within the target voltage interval is usually present acting on the load connection. Such a voltage can be further processed particularly easily.

The rechargeable batteries that are connected are, in particular, already connected to the rechargeable battery discharge device before they are connected, but they are not connected in series. In other words, these rechargeable batteries do not release any electrical energy. The larger the number of connections of the rechargeable battery discharge device, the less frequently new rechargeable batteries to be discharged must be connected to the rechargeable battery discharge device. This facilitates operation.

The upper interval boundary of the target voltage interval is preferably at most 60 Volt. In this case, special protective measures such as protective clothing are usually not required.

Preferably, the number of rechargeable battery connections is greater than five, especially greater than 10. It is often advantageous if the number of rechargeable battery connections is smaller than 150, especially smaller than 30.

According to a preferred embodiment, the rechargeable battery discharge device has a load for dissipating the electric output during discharging of the rechargeable batteries. For example, the load is an inverter for generating an AC voltage of a predetermined frequency and voltage from the DC voltage acting on the load connection. Alternatively, the load is a DC voltage converter, for example, for generating a DC voltage of a predetermined voltage from the DC voltage acting on the load connection. The inverter may be a switched-mode power supply, for example.

The feature that the load, in particular the inverter, is connected to the load connection is understood particularly to mean that the inverter is electrically connected to the load connection. It is possible, but not essential, for the load connection to be a special device, such as a socket. In particular, the load connection may be composed of two or more electrical conductors, by means of which the load can be connected.

It is advantageous if the inverter is connected to a public grid to feed electrical energy back into the public power grid.

Preferably, the inverter is connected to a power grid—this can be, but does not have to be, the public power grid—to which electrical consumers are connected. For example, at least one consumer constitutes part of a lithium battery recycling system for recycling lithium batteries. In particular, at least one electrical consumer can be a comminution plant for comminuting lithium batteries, a pump, such as a vacuum pump, or a motor.

According to a preferred embodiment, the control unit is designed to automatically carry out a method comprising the steps (i) detecting a target power output of the rechargeable battery discharge device and (ii) reducing a discharge capacity of the rechargeable batteries when an actual power output exceeds the target power output. For example, the target power output can be read from an input device or memory, or detected by a power meter.

It is especially advantageous if the detection of the target power output is a detection of an instantaneous power demand of the electrical consumers of the power grid. Technical systems, such as a lithium battery recycling system, require fluctuating quantities of electric power. If the actual power output of the rechargeable battery discharge device, i.e. the instantaneous electrical power output, is greater than the instantaneous power demand of the electrical consumers of the power grid, electric power is generally fed back into the public grid. The compensation for electrical energy fed back in this way is relatively small. Therefore, it may be advantageous to throttle the power output of the rechargeable battery discharge device when it exceeds the instantaneous power demand of the electrical consumers of the power grid.

According to a preferred embodiment, the rechargeable battery discharge device is an electrical buffer store. The buffer store is preferably is connected in such a way that electrical energy, which is taken from the rechargeable batteries by the rechargeable battery discharge device, is stored at least partially and/or at least temporarily in the buffer store.

It is advantageous if the buffer store has a storage capacity of at least 10 kWh or at least 30 kWh, especially at least 50 kWh. The storage capacity of the buffer store is usually smaller than 10 MWh.

The control unit is preferably configured to automatically carry out a method comprising the steps: (I) detecting a target power output of the rechargeable battery discharge device and (ii) loading the buffer store, so that the actual power output does not exceed the target power output. In other words, the control unit is designed to store electrical energy in the buffer store that is not needed by the consumers of the power grid.

It is beneficial if the rechargeable battery discharge device has at least one rechargeable battery connected to the first rechargeable battery connection. In particular, the rechargeable battery discharge device comprises a plurality of rechargeable batteries, each of which is connected to a rechargeable battery connection.

Preferably, the rechargeable battery discharge device has at least one heat sensor, especially a thermal imaging camera, that is arranged to detect a temperature of at least one of the rechargeable batteries. If a rechargeable battery heats up too much, it may cause a runaway, i.e. catastrophic failure of the rechargeable battery due to a self-reinforcing discharge. To avoid such an event, according to a preferred embodiment, the temperature of the rechargeable batteries is continuously detected. If the temperature exceeds a warning temperature, the control unit automatically removes the corresponding rechargeable battery from the series circuit. Alternatively or additionally, the control unit automatically removes the corresponding rechargeable battery from the series circuit if a temperature change rate \dot{T}, i.e. the—numerically calculated—derivative of the temperature Tᵢ after the time t exceeds a predetermined warning temperature change rate \dot{T}_{warn}.

The control unit is preferably configured to automatically carry out a method comprising the following steps: (a) detecting a rechargeable battery that is connected to a rechargeable battery connection and does not exceed the minimum voltage Uₘᵢₙ and (b) closing a first switch element, especially a short circuit relay, of the short circuit switch of the rechargeable battery connection or keeping said element closed.

The method preferably includes the step (c) closing a second switch element, especially a connecting relay, of the short circuit switch of the rechargeable battery connection or keeping said element closed.

Alternatively or additionally, the method preferably includes the step (d) emitting a signal which encodes that the rechargeable battery can be removed.

It is advantageous if the control unit is configured to automatically carry out a method comprising the following steps, which are preferably carried out after the steps specified in the three previous paragraphs: (a) detecting that there is no rechargeable battery connected to the rechargeable battery connection, (b) opening the second switch element or keeping said element open and, where applicable, (c) opening the first switch element or keeping said element open. This prevents or reduces the formation of an electric arc in the first switch element. The method preferably also includes the steps (c) closing the connecting relay or keeping said relay closed. Steps (b) and (c) preferably occur within a maximum of 1 second, especially a maximum of 0.1 seconds.

Detecting that there is no rechargeable battery connected to the rechargeable battery connection is achieved, for example, by means of the respective voltmeter or by reading a user entry from a control element such as a switch or button.

Detecting that there is no rechargeable battery connected to the rechargeable battery connection is achieved, for example, by applying a voltage pulse, preferably at most 60 Volt, to the rechargeable battery connection, especially if the voltmeter does not measure a voltage acting on the rechargeable battery connection. If this does not result in an electric current, no rechargeable battery is connected.

In particular, the first switch elements are connected in such a way that the series circuit is only closed when all first switch elements are closed. Specifically, the first switch elements are connected in such a way that the output voltage U_{A} is present and thus the rechargeable batteries connected in the series circuit can be discharged when—in particular only when—all first switch elements are closed.

In particular, the second switch elements are connected in such a way that the following applies for each switch element: irrespective of the switching state of the first switch element, the rechargeable battery connected to the corresponding rechargeable battery connection can only be discharged when the second switch element is closed.

A method according to the invention preferably comprises the steps described within the context of the preferred embodiment of the control unit.

In the following, the invention will be explained in more detail with the aid of the accompanying drawing. It shows:

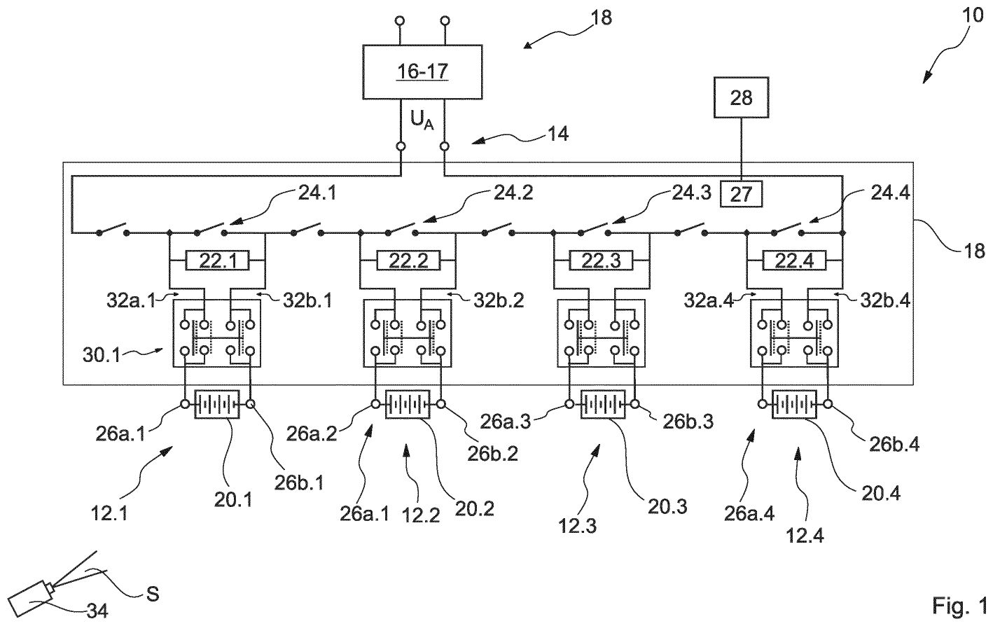

FIG. 1 a circuit diagram of a rechargeable battery discharge device according to the invention,

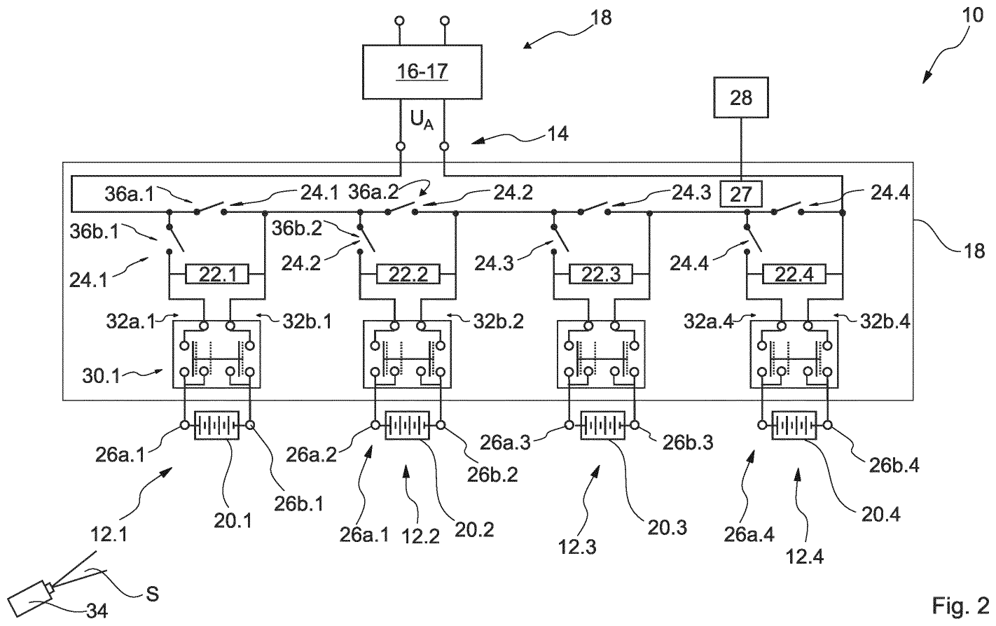

FIG. 2 a circuit diagram of a rechargeable battery discharge device according to the invention according to a second embodiment and

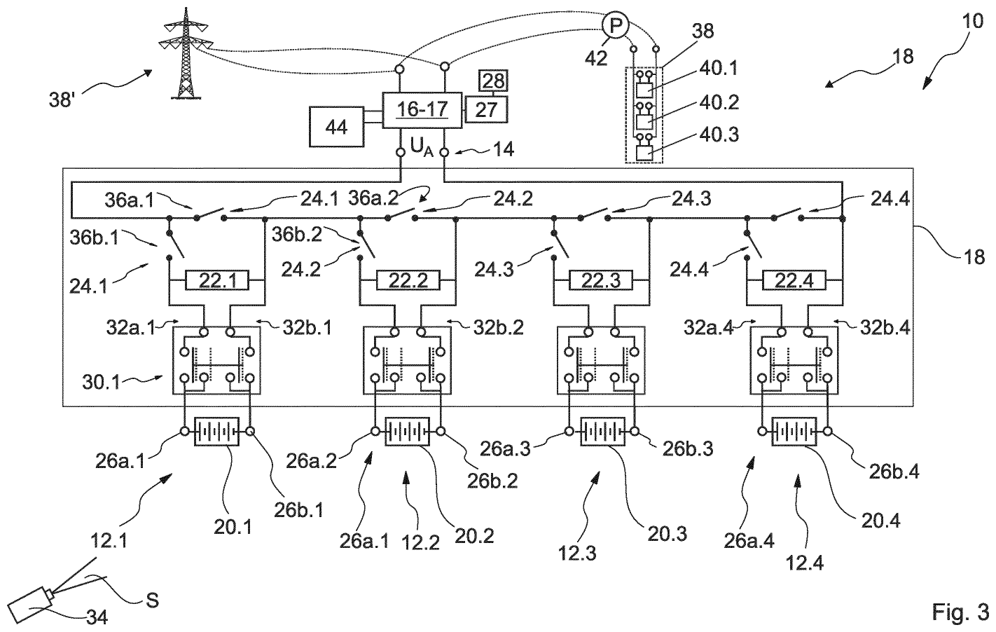

FIG. 3 an alternative embodiment of a rechargeable battery discharge device according to the invention.

FIG. 1 shows a rechargeable battery discharge device 10 according to the invention with rechargeable battery connections 12.i (i=1, 2, . . . , N; here: N=4). The rechargeable battery discharge device 10 also has a load connection 14 to which, in the present case, a load 16 in the form of an inverter 17 is connected. The inverter 17 has a voltage connection 18 to which an AC voltage U_{AC} with a predetermined frequency f is applied, for example 50 Hertz or 60 Hertz. The AC voltage U_{AC} is 230 Volt or 110 Volt, for example. However, other voltages are possible.

For each rechargeable battery connection 12.i, the discharge circuit 18 has a voltmeter 22.i for measuring a rechargeable battery voltage U_{20.i} of the respective connected rechargeable battery 20.i. The discharge circuit 18 also has a short circuit switch 24.i for each rechargeable battery connection 12. The respective rechargeable battery connection 12.i can be short-circuited by means of each short circuit switch 24.i. In other words, respective connection contacts 26a.i of the rechargeable battery connection 12.i can be switched to the same potential. In this way, current no longer flows through the corresponding rechargeable battery 20.i.

The rechargeable battery discharge device 10 has a control unit 27 that is connected to all voltmeters 22.i, so that the control unit 27 detects all rechargeable battery voltages U_{20.i}. The control unit 27 is also connected to all short circuit switches 24.i for control purposes. In other words, the control unit 27 can automatically close and open each short circuit switch 24.i.

The rechargeable battery discharge device 10 may have a display 28 that is connected to the control unit 27 by means of a conductor or via radio connection and designed to display the rechargeable battery connections 12.i to which a rechargeable battery voltage 20.i is applied that is smaller than a predetermined minimum voltage Uₘᵢₙ or the rechargeable battery connections 12.i where the respective short circuit switch 24.i is closed. An operator of the rechargeable battery discharge device 10 can then remove the corresponding rechargeable battery 12.i as it is discharged. For example, the minimum voltage is zero Volt.

It is also possible, but not essential, that the rechargeable battery discharge device comprises a polarity reversal protection circuit 30.i for at least one rechargeable battery connection, particularly for all rechargeable battery connections 12.i. If the voltmeter 22.i measures an incorrect polarity of the connected rechargeable battery, i.e. If the rechargeable battery is connected with the incorrect polarity, the control unit 27 controls the polarity reversal protection circuit 30.i in such a way that it reverses the polarity, so that the polarity reversal circuit connections 32a.1, 32b.1 are again connected with the right polarity.

The control unit 27 is configured in such a way that it automatically and continuously detects the rechargeable battery voltages U_{20.i}. If a rechargeable battery voltage U_{20.i} is greater than the minimum voltage Uₘᵢₙ, the control unit 27 keeps the respective short circuit switch 24.i open. If all rechargeable battery voltages 20.i are greater than the minimum voltage Uₘᵢₙ, all short circuit switches 24.i are closed and all rechargeable batteries 20.i are connected to one another in a series circuit. The rechargeable battery voltages U_{20.i} thus add up to an output voltage U_{A}, which is applied to the load connection 14 and corresponds to the sum of all rechargeable battery voltages U_{20.i} when in the load-free state.

If the rechargeable battery voltage U_{20.i} falls below the minimum voltage Uₘᵢₙ for one rechargeable battery 20.i, the control unit 27 closes the respective short circuit switch 24.i, so that the corresponding rechargeable battery 20.i is bridged. Current then no longer flows through the corresponding rechargeable battery 20.i. If the minimum voltage Uₘᵢₙ is not selected to be zero Volt, the discharge circuit 18 has an additional switch for each rechargeable battery connection 12.i, said switch separating one of the two connection contacts 26a.i or 26b.1 from the rest of the circuit.

To ensure that the output voltage U_{A} always remains within a predetermined target voltage interval Z, the control unit 27 can be designed in such a way that it only connects some of the rechargeable batteries 20.i into series and bridges the remaining rechargeable batteries, so that the corresponding output voltage U_{A} is reached.

The display 28 can be used to emit warnings, for example a polarity reversal warning or a voltage disconnection warning, if the control unit 27 detects that a change in the rechargeable battery voltage \dot{U} is too stark. The change in the rechargeable battery voltage \dot{U} is calculated by the control unit 27 by numerically deriving the respective rechargeable battery voltage U_{20.3}.

The respective temperatures Tᵢ of the rechargeable batteries 20.i are monitored by means of a heat sensor 34, in the present case in the form of a thermal imaging camera 34 in whose field of view S the rechargeable batteries are located. The heat sensor 34 is connected to the control unit 27. If one of the temperatures Tᵢ exceeds a predetermined warning temperature T_{warn}, the control unit 27 decontacts the corresponding rechargeable battery 20.i. According to a preferred embodiment, the control unit 27 reconnects the corresponding rechargeable battery 20.i into the series circuit after a predetermined waiting time. Alternatively to the thermal imaging camera, the heat sensor may also have thermocouples, for example.

FIG. 2 shows a circuit diagram of a rechargeable battery discharge device 10 according to the invention according to a second embodiment. In this embodiment, the short circuit switches 24.i have a first switch element 36a.i and a second switch element 36b.i. The switch elements 36a.i, 36b.i are, for example, relays. In this way, a rechargeable battery 20.i can be decontacted when its rechargeable battery voltage U_{20.i} falls below the minimum voltage Uₘᵢₙ, wherein Uₘᵢₙ≠0 V applies for the minimum voltage.

The switch elements 36a.i can also be referred to as short circuit relays. The switch elements 36b.i can also be referred to as connecting relays. The connecting relay switches.

A target voltage interval Z is stored in the control unit 27. The control unit 27 automatically connects so many rechargeable batteries 20.i into series that the resulting sum voltage lies within the target voltage interval Z. The connection of a rechargeable battery 20.i is achieved by opening the corresponding short circuit relay 36a.i and closing the connecting relay 36b.i. As a result, the rechargeable battery releases electrical energy. This preferably, but not necessarily, occurs automatically, for example by means of the control unit 27.

The disconnection of a rechargeable battery 20.i is achieved by (a) closing the corresponding short circuit relay 36a.i or keeping it closed, and (b) opening the connecting relay 36b.i or keeping it open. After removing a rechargeable battery from its rechargeable battery connection 12.i., the connecting relay 36b.i is opened. A further rechargeable battery 20′.i is then connected to the rechargeable battery connection 12.i. If necessary, the corresponding short circuit relay 36a.i is then opened and the connecting relay 36b.i closed. This also preferably, but not necessarily, occurs automatically, for example by means of the control unit 27. The new rechargeable battery 20′.i is then connected.

The N number of rechargeable battery connections is preferably selected in such a way that not all rechargeable batteries have to be connected in series for the sum voltage to be within the target voltage interval Z. The number N is preferably selected in such a way that at most half, in particular at most one third, of the rechargeable battery connections have to be contacted for the sum voltage to lie within the target voltage interval Z.

If a rechargeable battery has reached or fallen below the minimum voltage Uₘᵢₙ, it is bridged, as described above. It is then advantageous, but not essential, for the control unit 27 to emit a signal that the corresponding rechargeable battery can be removed.

FIG. 3 depicts an alternative embodiment of a rechargeable battery discharge device 10 according to the invention, the inverter 17 of which is connected to a public power grid 38′ for feeding electrical energy back into it.

Alternatively or additionally, the inverter 17 is connected to a power grid 38 to which electrical consumers 40.j (j=1, 2, . . . J) are connected. The electrical power P₄₀ of the electrical consumers 40.j can be measured as a function of time by means of a power meter 42.

The control unit 27 is designed to automatically detect the electric output P₄₀, which represents a target power output Pₛₒₗₗ of the rechargeable battery discharge device 10. If the actual power output Pᵢₛₜ of the rechargeable battery discharge device 10 falls below the target power output Pₛₒₗₗ, power is taken from the public power grid 38′. However, if the actual power output Pᵢₛₜ exceeds the target power output Pₛₒₗₗ, the electric output is fed into the public grid 38′. To prevent this, the control unit can be designed to reduce the actual power output Pᵢₛₜ by, for example, disconnecting one or multiple rechargeable batteries from the circuit.

Alternatively or additionally, the rechargeable battery discharge 10 may comprise an electrical buffer store 44. The buffer store 44 can be a rechargeable battery, for example. The buffer store 44 is connected in such a way that electrical energy, which is taken from the rechargeable batteries 20 by the rechargeable battery discharge device 10, can be stored at least partially and/or at least temporarily in the buffer store.

For example, the control unit 27 is designed in such a way that electric output is introduced into the buffer store 44 when the target power output Pₛₒₗₗ is smaller than the actual power output Pᵢₛₜ. For example, so much electric output is introduced into the buffer store 40 that the electrical energy introduced into the public power grid 38′ is minimised.

### REFERENCE LIST

| | |
|---|---|
| 10 | rechargeable battery discharge device |
| 12 | rechargeable battery connection |
| 14 | load connection |
| 16 | load |
| 17 | inverter |
| 18 | discharge circuit |
| 20 | rechargeable battery |
| 22 | voltmeter |
| 24 | short circuit switch |
| 26 | connection contacts |
| 27 | control unit |
| 28 | display |
| 30 | polarity reversal protection circuit |
| 32 | polarity reversal circuit connection |
| 34 | thermal imaging camera |
| 36a | first switch element, short circuit relay |
| 36b | second switch element, connecting relay |
| 38 | power grid |
| 38′ | public power grid |
| 40 | consumer |
| 42 | power meter |
| 44 | buffer store |
| f | frequency |
| i | running index of rechargeable battery connections |
| j | running index of consumers |
| N | number of rechargeable battery connections |
| Pₛₒₗₗ | target power output |
| Pᵢₛₜ | actual power output |
| S | field of view |
| Ti | temperature of the i-th rechargeable battery |
| T_{warn} | warning temperature |
| U_{AC} | AC current |
| U_{20.i} | rechargeable battery voltage |
| Uₘᵢₙ | minimum voltage |
| U_{A} | output voltage |
| \dot{U} | change in rechargeable battery voltage |
| Z | target voltage interval |

1. A rechargeable battery discharge device for discharging rechargeable batteries comprising
a first rechargeable battery connection for connecting a first rechargeable battery,
a second rechargeable battery connection for connecting a second rechargeable battery,
at least a third rechargeable battery connection for connecting a third rechargeable battery, and
a load connection for a load for dissipating an electric output during discharging of the rechargeable batteries,
a discharge circuit comprising
a first short circuit switch,
a first voltmeter that is arranged to measure a first rechargeable battery voltage dropped across the first rechargeable battery connection,
a second short circuit switch,
a second voltmeter that is arranged to measure a second rechargeable battery voltage dropped across the second rechargeable battery connection,
a third short circuit switch,
a third voltmeter that is arranged to measure a third rechargeable battery voltage dropped across the third rechargeable battery connection, and
a control unit,
the control unit being configured to automatically carry out a method comprising the steps:
for all of the first, second, and third voltmeters, detecting the respective first, second, or third rechargeable battery voltage,
when the respective first, second, or third rechargeable battery voltage exceeds a predetermined minimum voltage, connecting the corresponding first, second, or third rechargeable battery into a series circuit with at least one other rechargeable battery and
when the respective first, second, or third rechargeable battery voltage does not exceed the predetermined minimum voltage, removing the corresponding first, second, or third rechargeable battery from the series circuit by means of the corresponding first, second, or third short circuit switch.

2. The rechargeable battery discharge device according to claim 1, further comprising a load connected to the load connection in the form
of an inverter for generating an AC voltage of a predetermined frequency and voltage and/or
a DC voltage converter for generating a DC voltage of a predetermined voltage, from a DC voltage acting on the load connection.

3. The rechargeable battery discharge device according to claim 1, further comprising a display for displaying
any of the first, second, and third rechargeable batteries whose respective first, second, or third rechargeable battery voltage falls below the minimum voltage and/or
any of the first, second, and third rechargeable battery connections whose connection contacts are short-circuited.

4. The rechargeable battery discharge device according to claim 1, further comprising a polarity reversal protection circuit for automatically
detecting a rechargeable battery connected with an incorrect polarity and emitting a polarity reversal warning and/or
connecting an incorrectly connected rechargeable battery with a correct polarity.

5. The rechargeable battery discharge device according to claim 1, wherein the control unit is configured to automatically perform further steps of:
(i) determining changes in the first, second, and third rechargeable battery voltages over time and
(ii) bridging the corresponding first, second, or third rechargeable battery by means of the corresponding first, second, or third short circuit switch and/or emitting a voltage disconnection warning when a determined change in first, second, or third rechargeable battery voltage over time lies outside of a predetermined tolerance interval.

6. The rechargeable battery discharge device according to claim 1, wherein the control unit is configured to automatically perform a further step of:
connecting some of the first, second, and third rechargeable batteries into the series circuit so that a sum of the corresponding first, second, or third rechargeable battery voltages lies within a predetermined target voltage interval, wherein a combination with a largest number of rechargeable battery voltages is selected when two or more combinations of rechargeable battery voltages lie within the target voltage interval.

7. The rechargeable battery discharge device according to claim 1, further comprising at least one heat sensor arranged to detect a temperature of at least one of the first, second, and third rechargeable batteries.

8. The rechargeable battery discharge device according to claim 1, wherein the control unit is configured to automatically perform further steps of:
detecting a rechargeable battery among the first, second, and third rechargeable batteries that is connected to the respective first, second, or third rechargeable battery connection and does not exceed the minimum voltage,
closing a first switch element of the short circuit switch of the respective first, second, or third rechargeable battery connection, or keeping said first switch element closed,
closing a second switch element of the short circuit switch of the respective first, second, or third rechargeable battery connection, or keeping said second switch element closed,
emitting a signal that encodes that the detected rechargeable battery can be removed,
detecting that no rechargeable battery is connected to any rechargeable battery connection,
opening the second switch element or keeping it open, then
opening the first switch element or keeping it open, and then
closing the second switch element.

9. The rechargeable battery discharge device according to claim 2, wherein
the inverter is connected to a power grid to which electrical consumers) are connected,
the control unit is configured to automatically perform further steps of:
detecting a target power output of the rechargeable battery discharge device and
reducing a discharge output of the first, second, and third rechargeable batteries when an actual power output exceeds the target power output.

10. The rechargeable battery discharge device according to claim 9, further comprising
an electrical buffer store,
wherein the control unit is configured to perform further steps of:
detecting the target power output of the rechargeable battery discharge device (10) and
loading the buffer store so that the actual power output does not exceed the target power output.

11. A method for discharging a plurality of rechargeable batteries comprising the automatically performed steps:
continuously measuring one rechargeable battery voltage of a plurality of rechargeable batteries,
connecting the rechargeable batteries whose rechargeable battery voltages do not fall below a predetermined minimum voltage into a series circuit so that the rechargeable batteries are discharged, and
decontacting a rechargeable battery whose rechargeable battery voltage falls below the predetermined minimum voltage so that it is no longer connected in series.

12. The method according to claim 11, further comprising
emitting a notification that encodes the rechargeable batteries whose respective rechargeable battery voltage falls below the minimum voltage and/or rechargeable battery connections whose connection contacts are short-circuited.

13. The method according to claim 11, further comprising
detecting a rechargeable battery connected with an incorrect polarity and emitting a polarity reversal warning and/or
connecting an incorrectly connected rechargeable battery with a correct polarity.

14. The rechargeable battery discharge device according to claim 7, wherein the at least one heat sensor is a thermal imaging camera.

15. The rechargeable battery discharge device according to claim 8, wherein the first switch element is a short circuit relay and the second switch element is a connecting relay.
